(19) United States
(12) Patent Application Publication
(10) Pub. No.: US 2025/0316751 A1
(43) Pub. Date: Oct. 9, 2025

(54) Semi-solid-state Rechargeable Batteries

(71) Applicant: UIF (Univ.Ind. Fndtn), Yonsei University, Seoul (KR)

(72) Inventors: Sang-Young Lee, Seoul (KR); Won-Yeong Kim, Seoul (KR); Kyeong-Seok Oh, Seoul (KR); Seokhyeon Ryu, Seoul (KR)

(21) Appl. No.: 19/225,724

(22) Filed: Jun. 2, 2025

Related U.S. Application Data
(63) Continuation-in-part of application No. 18/809,604, filed on Aug. 20, 2024.
Application No. 18/809,604 is a continuation-in-part of application No. 18/523,013, filed on Nov. 29, 2023.
(63) Continuation-in-part of application No. 18/810,220, filed on Aug. 20, 2024.
Application No. 18/810,220 is a continuation-in-part of application No. 18/523,235, filed on Nov. 29, 2023.
(63) Continuation-in-part of application No. 18/809,580, filed on Aug. 20, 2024.
Application No. 18/809,580 is a continuation-in-part of application No. 18/524,006, filed on Nov. 30, 2023.

(30) Foreign Application Priority Data
Dec. 1, 2022 (KR) 10-2022-0166000
Sep. 19, 2023 (KR) 10-2023-0124943
Sep. 19, 2023 (KR) 10-2023-0124944
Nov. 8, 2023 (KR) 10-2023-0154002

(51) Int. Cl. H01M 10/056; H01M 10/052; H01M 10/42

(52) U.S. Cl. CPC H01M 10/056; H01M 10/052; H01M 10/4235; H01M 2300/0085; H01M 2300/0091

(57) ABSTRACT

A semi-solid rechargeable battery, comprising a positive electrode, a negative electrode, a composite electrolyte film comprising a solid-liquid composite electrolyte between the positive electrode and the negative electrode, and a SEI layer comprising LiF, Li₃N and organic components on the surface of the negative electrode, wherein the solid-liquid composite electrolyte comprises a sulfide-based solid electrolyte and a liquid electrolyte including a salt and an organic solvent.

### CROSS-REFERENCE TO RELATED APPLICATIONS

This application is a CIP (Continuation-In-Part) of U.S. patent application Ser. No. 18/809,604 file on Aug. 20, 2024, which is a CIP of U.S. patent application Ser. No. 18/523,013 filed on Nov. 29, 2023, which claims priority to and the benefit of Korean Patent Application No. 10-2022-0166000 filed in the Korean Intellectual Property Office on Dec. 1, 2022, and Korean Patent Application No. 10-2023-0124944 filed in the Korean Intellectual Property Office on Sep. 19, 2023, the entire contents of which are incorporated herein by reference.

This application is a CIP of U.S. patent application Ser. No. 18/810,220 filed on Aug. 20, 2024, which is a CIP of Ser. No. 18/523,235 filed on Nov. 29, 2023, which claims priority to and the benefit of Korean Patent Application No. 10-2022-0166000 filed in the Korean Intellectual Property Office on Dec. 1, 2022, and Korean Patent Application No. 10-2023-0124943 filed in the Korean Intellectual Property Office on Sep. 19, 2023, the entire contents of which are incorporated herein by reference.

This application is a CIP of U.S. patent application Ser. No. 18/809,580 filed on Aug. 20, 2024, which is a CIP of U.S. patent application Ser. No. 18/524,006 filed on Nov. 30, 2023, which claims priority to and the benefit of Korean Patent Application No. 10-2022-0166000 filed in the Korean Intellectual Property Office on Dec. 1, 2022, and Korean Patent Application No. 10-2023-0154002 filed in the Korean Intellectual Property Office on Nov. 8, 2023, the entire contents of which are incorporated herein by reference.

### BACKGROUND OF THE INVENTION

### (a) Field of the Invention

A semi-solid rechargeable battery including a solid-liquid composite electrolyte and Solid Electrolyte Interphase (SEI) layer is disclosed.

### (b) Description of the Related Art

General rechargeable batteries use a flammable electrolyte and have a safety issue such as explosion or fire, when problems such as collision or penetration, etc. occur. Accordingly, all-solid rechargeable batteries or semi-solid rechargeable batteries using a solid electrolyte instead of an electrolyte solution are being proposed. The batteries using solid electrolytes are safe with no risk of explosion due to electrolyte leakage. They also enhance energy density by employing thin electrodes, such as lithium metal, improve rapid charging and discharging performance and realize high-voltage driving and high energy density. In particular, sulfide-based solid electrolytes have recently attracted much attention due to their high ionic conductivity comparable with liquid electrolytes and high transference number (t_{Li+}˜1).

However, the sulfide-based solid electrolyte has a problem of deterioration of ionic conductivity performance due to resistance generated on the interface with other solid particles such as a positive electrode active material and the like in the batteries and a depletion layer formed by joining the solids.

Accordingly, research on solving the problems of the solid electrolyte is underway by adding a liquid electrolyte to the sulfide-based solid electrolyte to prepare a solid-liquid composite electrolyte. However, conventional studies to combine the sulfide-based solid electrolyte with the liquid electrolyte have the following limitations. First, a chemical side reaction on the interface of the liquid electrolyte, which is generally highly polar, with the sulfide-based solid electrolyte, second, high resistance against movement of lithium ions on the interface of the liquid electrolyte with the sulfide-based solid electrolyte, third, deterioration of single ionic conductivity due to a low lithium ion yield (Li+transference number) of the liquid electrolyte, forth, flame retardant loss due to introduction of the liquid electrolyte, which is flammable, into the sulfide-based solid electrolyte, and fifth, low oxidation stability of conventional composite electrolytes, resulting in an unstable interface with a positive electrode.

In addition, solid-liquid composite electrolytes including the sulfide-based solid electrolytes tend to undergo side reactions with negative electrodes such as lithium metal, resulting in the problem that a stable SEI layer does not form on the negative electrode surface.

### SUMMARY OF THE INVENTION

In some embodiments provide a semi-solid rechargeable battery comprising a positive electrode, a negative electrode, a composite electrolyte film comprising a solid-liquid composite electrolyte between the positive electrode and the negative electrode, and a SEI layer comprising LiF, Li₃N, and organic components on the surface of the negative electrode. The solid-liquid composite electrolyte comprises a sulfide-based solid electrolyte and a liquid electrolyte including a salt and an organic solvent.

The semi-solid rechargeable battery according to some embodiments can form a stable and ideal SEI layer on the surface of the negative electrode, and thus can realize excellent electrochemical performance such as cycle-life stability.

### BRIEF DESCRIPTION OF THE DRAWINGS

FIG. 1 is an image schematically showing a semi-solid rechargeable battery according to some embodiments.

FIG. 2 presents the X-ray Photoelectron Spectroscopy (XPS) results for the SEI layers on the negative electrode of Comparative Example 1 (left) and Example 1 (right).

FIG. 3 is a graph showing voltage changes over time for Example 1 and Comparative Example 1 when charge and discharge were repeated at 5 MPa.

FIG. 4 is a graph showing voltage changes over time for Example 1 and Comparative Example 1 when charge and discharge were repeated at 0 MPa.

### DETAILED DESCRIPTION OF THE EMBODIMENTS

Hereinafter, specific embodiments will be described in detail below. However, this disclosure may be embodied in many different forms and is not construed as limited to the example embodiments set forth herein.

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

In addition, the average particle diameter may be measured by a method well known to those skilled in the art, for example, may be measured by a particle size analyzer, or may be measured by a transmission electron microscopic image or a scanning electron microscopic image. Alternatively, it is possible to obtain an average particle diameter value by measuring it using a dynamic light scattering method, performing data analysis, counting the number of particles for each particle size range, and calculating from this. As used herein, when a definition is not otherwise provided, the average particle diameter may mean a diameter (D₅₀) of particles having a cumulative volume of 50 vol % in a particle size distribution. As used herein, when a definition is not otherwise provided, the average particle diameter means a diameter (D₅₀) of particles having a cumulative volume of 50 vol % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept that includes ordinary metals, transition metals, metalloids, and semi-metals.

### Semi-Solid Rechargeable Batteries

A semi-solid rechargeable battery according to some embodiments comprises a positive electrode, a negative electrode, a composite electrolyte film comprising a solid-liquid composite electrolyte between the positive electrode and the negative electrode, and a SEI layer comprising LiF, Li₃N, and organic components on the surface of the negative electrode. The solid-liquid composite electrolyte comprises a sulfide-based solid electrolyte and a liquid electrolyte including a salt and an organic solvent.

The positive electrode and the negative electrode each may comprise an electrode active material, and optionally comprise a binder and/or a conductive material. In addition, the positive electrode and/or the negative electrode may comprise an electrolyte, which may include, for example, a liquid electrolyte, a solid electrolyte, a solid-liquid composite electrolyte, or a combination thereof.

The semi-solid rechargeable battery can be described as a semi-solid-state rechargeable battery, and it may refer to a battery in which solid and liquid components are mixed within the cell or where parts of the solid and liquid are combined.

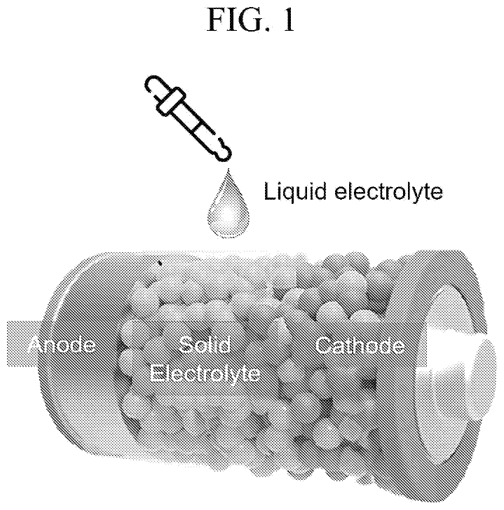

For easy understanding, a shape of the semi-solid rechargeable battery according to some embodiments is shown in FIG. 1. Although FIG. 1 shows one electrode assembly including the negative electrode, composite electrolyte film, and positive electrode, a semi-solid rechargeable battery can also be manufactured by stacking two or more electrode assemblies.

### SEI Layer

The SEI layer according to some embodiments includes LiF, Li₃N and organic components.

The SEI layer may refer to the interfacial layer formed between the negative electrode and the electrolyte, and mainly refer to a thin film formed by the decomposition of the electrolyte or chemical reactions between the electrolyte and electrode materials. According to some embodiments, the SEI layer may refer to a passivation layer formed on the surface of the negative electrode during the first charging process after the battery has been manufactured, rather than being artificially formed during the battery manufacturing process. For example, the SEI layer can be formed by charging (e.g., charging and discharging) at least once under the conditions ranging from about 0.01 mA/cm² to about 20 mA/cm² or from about 2.0 V to about 5.0 V, for about 1 second to about 20 hours.

The components that make up the SEI layer and the morphology of the SEI layer have a significant impact on the electrochemical performance, including the cycle stability of the battery. Accordingly, extensive research has been conducted on the SEI layer in batteries using liquid electrolytes.

However, when using sulfide-based solid electrolytes, side reactions occur between the sulfide-based solid electrolyte and electrode materials, preventing the formation of a stable SEI, and consequently making it difficult to secure long-term cycle-life characteristics. In addition, a narrow electrochemical stability window of the sulfide-based solid electrolytes leads to the formation of sulfide-based SEI layers including Li₂S and P—S—Li, on the negative electrode surface. These SEI layers exhibit issues including low ionic conductivity, high electronic conductivity, poor mechanical properties, and low adhesion energy.

Meanwhile, techniques for introducing artificial protective films on electrode surfaces during battery manufacturing processes have been proposed. However, these techniques have the drawback of reducing energy density, and interface resistance occurs between the protective layer and the electrode, as well as between the protective layer and the electrolyte, leading to additional side reactions between these interfaces. Such protective films are currently unable to demonstrate effects that surpass the SEI formed during the charging process.

In contrast, the semi-solid rechargeable battery includes the composite electrolyte comprising the sulfide-based solid electrolyte and the liquid electrolyte, accordingly, in addition to sulfide-based components, inorganic components and organic components based on the liquid electrolyte can be formed as the SEI. This SEI may exhibit superior characteristics compared to sulfide-based SEI.

In particular, the semi-solid rechargeable batteries according to some embodiment can form a stable SEI including LiF, Li₃N and organic components, and such SEI can achieve high ionic conductivity, low electronic conductivity, high mechanical properties, and high adhesive energy, thereby stabilizing the electrodes and the solid-liquid composite electrolyte during charge and discharge and significantly improving the cycle-life characteristics. The SEI layer according to some embodiment can suppress the reaction between the electrodes and the solid-liquid composite electrolyte, facilitate the movement of lithium ions while inhibiting the growth of lithium dendrites on the negative electrode.

In the SEI layer according to some embodiments, LiF exhibits low electronic conductivity and high Young's modulus, while Li₃N has high ionic conductivity and adhesion. Therefore, the SEI layer that includes both of LiF and Li₃N can improve the electrochemical performance of the battery by facilitating the movement of lithium ions between the positive electrode and negative electrode and lowering the resistance, prevent short circuits by blocking the movement of electrons to the solid-liquid composite electrolyte, and enhance the safety of the battery. In addition, it can prevent lithium dendrites on the negative electrode and stabilize the negative electrode, enabling more stable operation of the battery.

Additionally, unlike technologies that only introduce LiF and Li₃N to the SEI layer, the SEI layer according to some embodiments additionally includes organic components, which can further lower ionic conductivity and improve the mechanical flexibility of the SEI layer. Accordingly, the SEI layer can further stabilize the negative electrode during the charge and discharge process and further improve cycle-life and safety of the batteries.

LiF and Li₃N can be formed through reactions between the solid-liquid composite electrolyte and the negative electrode or through the decomposition of the solid-liquid composite electrolyte, such as by the decomposition of the liquid electrolyte within the solid-liquid composite electrolyte. For example, LiF and Li₃N may be components derived from salts, organic solvents, and/or additives in the liquid electrolyte.

The organic components may refer to substances containing carbon, for example, components derived from the organic solvent in the liquid electrolyte, or decomposition products of the organic solvent. For example, the organic components in the SEI layer may comprise at least one bonds of —CO₃, —CO—, —CO₂—, —OCH₂—, —CH₂—, —C—Li, and C—F. For example, the organic components may include Li₂CO₃, ROCO₂Li (R is an organic group), Li₂C₂, polymeric species, or a combination thereof. The presence and types of these organic components can be identified through XPS analysis of the negative electrode surface of a battery that has been charged at least once.

The SEI layer may additionally comprise —SO₂, —SO₃, S—N—S, N—S—N, N—SOₓ (2≤x≤4), SOₓ—F (2≤x≤3), LiₓSO_{y} (1≤x≤2, 0≤y≤6), P—S—Li, Li₂O, LiOH, LiNSO₂F, Li₂SO₃, LiNO₂, LiNO₃, Li₂S, Li₂SO₄, LiCl, LiBr, LiI, or a combination thereof. These may be components derived from a solid-liquid composite electrolyte according to some embodiments and, for example, may originate from salts, organic solvents, additives of a liquid electrolyte, and/or sulfide-based solid electrolytes.

In some embodiments, a ratio Ri of a peak area of an inorganic component to a peak area of an organic component calculated by Formula 1 may be greater than or equal to about 0.2 in the XPS analysis of the SEI layer.

$${R}_{1} = ( a peak area of LiF , {Li}_{3} N and N - {SO}_{x} ) / ( a peak area of C 1 s except for C - C ) \qquad [ Formula 1 ]$$

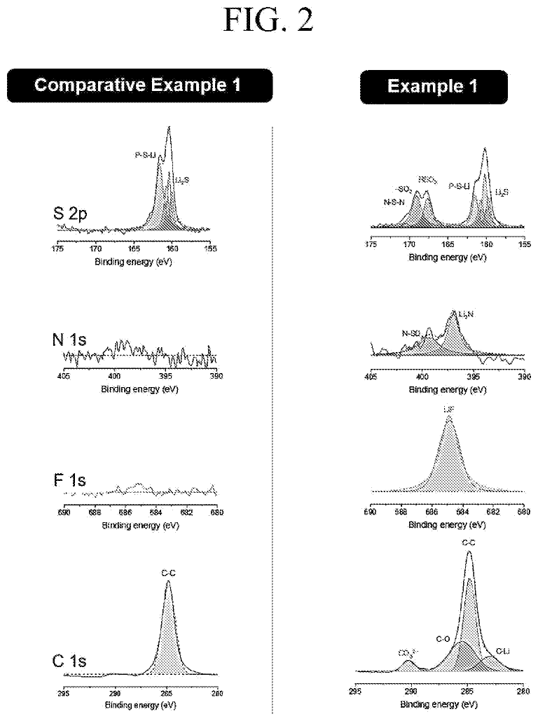

In Formula 1, each peak refers to the peaks observed in the XPS analysis of the SEI layer on the negative electrode surface of a battery that has been charged at least once, and the peak area may represent the integral value of a peak, as shown in FIG. 2. In Formula 1, LiF, Li₃N, and N—SOₓ may be referred to as inorganic components, and the numerator of R₁ may be referred to as the sum of the LiF peak area, the Li₃N peak area, and the N—SOₓ peak area. The denominator of R₁ may represent the integral values of the peaks of organic components, and the reason for excluding the C—C peak in the C 1s spectrum is that the C—C peak does not correspond to peaks of the sample (SEI layer on the negative electrode surface). For example, the denominator of R₁ may represent the sum of the peak areas of, for example, —CO₃, —CO—, —C—Li, etc.

According to some embodiments, the SEI may satisfy R₁ of about 0.2 or above, for example, about 0.2 to about 0.8, about 0.2 to about 0.6, between about 0.2 and about 0.5, or between about 0.2 and about 0.4. When Ri satisfies the above range, it indicates that LiF, Li₃N, and organic components are formed in the SEI layer in desirable ratios, and accordingly, the SEI can function as a stable passive layer with high ionic conductivity (e.g., >10⁻⁴ S/cm), low electronic conductivity, high mechanical property, and high interfacial adhesion energy (e.g., greater than 100 mJ/m²), thereby significantly improving the electrochemical performance of the batteries.

In some embodiments, a ratio R₂ of a peak area of an inorganic component to a peak area of an organic component and the inorganic component calculated by Formula 2 may be greater than or equal to about 0.1 in an XPS analysis of the SEI layer.

$${R}_{2} = ( a peak area of LiF , {Li}_{3} N and N - {SO}_{x} ) / ( a peak area of LiF , {Li}_{3} N , N - {SO}_{x} and C 1 s except for C - C ) \qquad [ Formula 2 ]$$

In Formula 2, each peak refers to the peaks in the XPS analysis of the SEI layer on the negative electrode surface of a cell that has been charged at least once, and the peak area may represent the integral value of the peak. In Formula 2, LiF, Li₃N, and N—SOₓ may be considered inorganic components, and the components of the C 1s spectrum may be considered organic components.

The SEI layer may satisfy R₂ of about 0.1 or higher, for example, satisfying ranges of about 0.1 to about 0.7, about 0.1 to about 0.5, about 0.1 to about 0.4, or about 0.1 to about 0.3. When R₂ satisfies the range, LiF, Li₃N, and organic components have been formed in the SEI layer in desirable proportions, and accordingly, the SEI can exhibit high ionic conductivity and low electronic conductivity while providing high mechanical properties and adhesion energy, thereby serving as an ideal and stable passivation layer. Consequently, the electrochemical performance of the batteries can be improved.

According to the XPS analysis of the SEI layer, in the S 2p spectra, the ratio of peak areas of components derived from the solid-liquid composite electrolyte to those derived only from the sulfide-based solid electrolyte may satisfy ratios of about 30:70 to about 70:30, about 40:60 to about 60:40, or about 40:50 to about 50:60. Such SEI layers can function as stable and ideal passive films and improve the cycle-life characteristics of the battery.

In some embodiments, a content of fluorine may be greater than or equal to 5 at %, for example, 5 at % to 50 at %, or 10 at % to 30 at % based on the total 100 at % of elements in a X-ray photoelectron spectroscopy (XPS) analysis of the SEI layer. In addition, In some embodiments, a content of nitrogen may be greater than or equal to 3 at %, for example, 3 at % to 40 at %, or 5 at % to 20 at % based on the total 100 at % of elements in the XPS analysis of the SEI layer. When the fluorine and nitrogen satisfy the content range, the SEI layer can function as an ideal and stable passive layer by exhibiting high ionic conductivity and low electronic conductivity, while possessing excellent strength and adhesion energy, thereby improving the battery's cycle-life characteristics.

A thickness of the SEI layer may be about 5 nm to about 5 μm, for example, about 5 nm to about 4 μm, about 5 nm to about 3 μm, about 5 nm to about 2 μm, about 5 nm to about 1 μm, or about 10 nm to about 900 nm. Within this range, the semi-solid rechargeable battery including the SEI layer may realize stable cycle life over 300 cycles with capacity retention exceeding 80%.

The SEI layer may be in contact with both the solid electrolyte and the liquid electrolyte of the solid-liquid composite electrolyte. Accordingly, the SEI layer may include components originating from the solid electrolyte as well as those originating from the liquid electrolyte.

### Solid-Liquid Composite Electrolyte

The biggest problem in combining the sulfide-based solid electrolyte and the liquid electrolyte is that the sulfide-based solid electrolyte and the liquid electrolyte chemically react to form a resistance layer, which reduces ionic conductivity. The liquid electrolyte includes a solvent, which is mainly polar, and this polar solvent strongly interacts with the sulfide-based solid electrolyte and thus easily causes a side reaction. For example, when a liquid electrolyte prepared by dissolving 1 M LiPF₆ in a carbonate-based solvent such as ethylene carbonate or propylene carbonate, etc. is combined with the sulfide-based solid electrolyte, since the liquid electrolyte and the solid electrolyte have high reactivity, which may cause a side reaction to form a resistance layer, ionic conductivity is rapidly deteriorated as reaction time goes.

Accordingly, recent studies have been conducted in the direction of selecting a nonpolar solvent rather than the polar solvent or a solvent having chemical stability with the sulfide-based solid electrolyte. For example, attempts have been proposed to combine a liquid electrolyte prepared by dissolving 1 M LiTFSI in a glyme-based solvent such as triethylene glycol dimethyl ether and the like with the sulfide-based solid electrolyte. However, the ionic conductivity deterioration over the reaction time has not been significantly improved.

Furthermore, attempts to combine a highly concentrated liquid electrolyte prepared by mixing the glyme based solvent and a lithium salt such as LiTFSI, LiBETI, and the like in a mole ratio of about 1:1 with the sulfide-based solid electrolyte have been proposed. Herein, there has been advantages of reducing the side reaction between the liquid electrolyte and the sulfide-based solid electrolyte and securing chemical stability but problems of deteriorating oxidation stability and thus causing an unstable interface of the sulfide-based solid electrolyte with a positive electrode at a high voltage and deteriorating or losing flame retardancy and heat resistance, which are advantages of the solid electrolyte and so, still limitations in application to actual batteries.

As another alternative, mixing an ionic liquid with a sulfide-based solid electrolyte instead of or in addition to the liquid electrolyte has been considered. However, in this case, there is a problem of a high decrease in ionic conductivity with reaction time and a decrease in flame retardancy and heat resistance. Likewise, the cost of ionic liquid is too high, and thus there is a limit to its application in actual batteries.

Accordingly, the present invention is to propose a composite electrolyte that not only improves ionic conductivity by suppressing side reactions between sulfide-based solid electrolyte and liquid electrolyte, but also improves high-voltage oxidation stability, heat resistance, and flame retardancy, and secures economic feasibility, so that it can be applied to practical batteries. Additionally, by applying such a solid-liquid composite electrolyte, a stable SEI layer containing LiF, Li₃N, and organic components is formed, providing a semi-solid secondary battery with further improved electrochemical properties.

The solid-liquid composite electrolyte in some embodiments is a composite of the solid electrolyte and the liquid electrolyte and may be expressed as a hybrid electrolyte or a mixed electrolyte, etc. The solid electrolyte and the liquid electrolyte may be physically mixed or chemically bonded to each other. For example, the liquid electrolyte may be disposed in pores between a plurality of solid electrolyte particles. Or the liquid electrolyte may be located on the surface of the solid electrolyte particles and may be attached, adsorbed, connected, or bonded to at least a portion of the surface of the solid electrolyte particles, for example, surround the surface of the solid electrolyte particles in the form of a film.

In some embodiments, the sulfide-based solid electrolyte may be included in about 10 vol % to about 99.99 vol % and the liquid electrolyte may be included in about 0.01 vol % to about 90 vol % based on 100 vol % of the solid-liquid composite electrolyte. For example, based on 100 vol % of the solid-liquid composite electrolyte, the sulfide-based solid electrolyte may be included in an amount of about 30 vol % to about 99.99 vol %, about 40 vol % to about 99.99 vol %, about 50 vol % to about 99.99 vol %, about 60 vol % to about 99.99 vol %, about 70 vol % to about 99.9 vol %, about 80 vol % to about 99.5 vol %, about 90 vol % to about 99 vol %, about 95 vol % to about 98 vol %, or about 90 vol % to about 95 vol % and the liquid electrolyte may be included in an amount of about 0.01 vol % to about 70 vol %, about 0.01 vol % to about 60 vol %, about 0.01 vol % to about 50 vol %, about 0.01 vol % to about 40 vol %, about 0.1 vol % to about 30 vol %, about 0.5 vol % to about 20 vol %, about 1 vol % to about 10 vol %, about 2 vol % to about 5 vol %, or about 5 vol % to about 10 vol %.

A weight ratio of the sulfide-based solid electrolyte and the liquid electrolyte may vary depending on the concentration of the liquid electrolyte. For example, based on 100 wt % of the solid-liquid composite electrolyte, the sulfide-based solid electrolyte may be included in an amount of about 50 wt % to about 99.99 wt % and the liquid electrolyte may be included in an amount of about 0.01 wt % to about 50 wt %. For example, based on 100 wt % of the solid-liquid composite electrolyte, the sulfide-based solid electrolyte may be included in an amount of about 30 wt % to about 99.99 wt %, about 40 wt % to about 99.99 wt %, about 50 wt % to about 99.99 wt %, about 60 wt % to about 99.99 wt %, about 70 wt % to about 99.99 wt %, about 80 wt % to about 99.99 wt %, about 90 wt % to about 99.99 wt %, about 95 wt % to about 99.99 wt %, about 99 wt % to about 99.99 wt %, about 90 wt % to about 99.9 wt %, or about 90 wt % to about 99 wt % and the liquid electrolyte may be included in an amount of about 0.01 wt % to about 70 wt %, about 0.01 wt % to about 60 wt %, about 0.01 wt % to about 50 wt %, about 0.01 wt % to about 40 wt %, about 0.01 wt % to about 30 wt %, about 0.01 wt % to 20 wt %, about 0.01 wt % to about 10 wt %, about 0.01 wt % to about 5 wt %, about 0.01 wt % to about 1 wt %, about 0.1 wt % to about 10 wt %, or about 1 wt % to about 10 wt %.

If the content of the liquid electrolyte in the solid-liquid composite electrolyte is excessive, battery safety may not be guaranteed due to loss of flame retardancy due to the liquid electrolyte or an inherent risk of battery explosion, and if the content of the liquid electrolyte is too low, the disadvantages of solid electrolytes may not be fully overcome and improvements in ionic conductivity and cyclability may not be significant. When the sulfide-based solid electrolyte and liquid electrolyte satisfy the above-mentioned content range, solid and liquid can be easily combined, high ionic conductivity can be maintained, and battery safety can be ensured.

In some embodiments, the liquid electrolyte, which is applied in a very small content to that of the sulfide-based solid electrolyte, may effectively solve the problems of the ionic conductivity deterioration, the resistance increase, and the like due to the sulfide-based solid electrolyte and also, realize high voltage oxidation stability, flame retardancy, and safety as well as an excellent ionic conductivity maintenance rate. For example, when the liquid electrolyte is included in an amount of less than or equal to about 15 vol %, less than or equal to about 10 vol %, less than or equal to about 5 vol %, or less than or equal to about 1 vol % based on 100 vol % of the solid-liquid composite electrolyte, the sulfide-based solid electrolyte and the liquid electrolyte may be easily combined, improving ionic conductivity, oxidation safety, and cyclability by the liquid electrolyte of some embodiments as well as securing safety of the solid electrolyte.

### Solid-Liquid Composite Electrolyte Including Sulfide-Based Solid Electrolyte and High-Kosmotropicity Salt-Containing Liquid Electrolyte

The solid-liquid composite electrolyte according to some embodiments may include a sulfide-based solid electrolyte and a liquid electrolyte, wherein the liquid electrolyte includes a salt and an organic solvent, and the salt includes a metal cation and an anion with a radius of less than about 295 pm. The unit of pm is a picometer, wherein 1 pm is 10⁻¹² m.

### Salt of the Liquid Electrolyte

Some embodiments are to suggest a direction of preparing a successful composite electrolyte by considering the Hofmeister effect of a salt, that is, controlling an interaction between the salt and an organic solvent in the liquid electrolyte. The embodiments are to select a kosmotropic anion as an anion forming the salt in the liquid electrolyte, that is, to design an anion with high kosmotropicity. The kosmotropic means “order” in Greek, which is the opposite concept of chaotropic. The higher kosmotropicity of the anion, the higher charge density and static electricity potential, which lead to the stronger interaction with the solvent, wherein the anion may not be rather dissolved in the solvent but tends to be salted out or aggregated. In other words, the anion with high kosmotropicity according to some embodiments has strong interaction energy with the solvent, the large solvation number of the anion, and a short bonding distance with the solvent. The anion with high kosmotropicity strongly attracts the solvent, which may deteriorate activity of the solvent and thereby effectively suppress a reaction between the solvent and the sulfide-based solid electrolyte. When the kosmotropic anion is applied, the chemical reaction of the liquid electrolyte and the sulfide-based solid electrolyte may be effectively suppressed even at a relatively low concentration of the salt.

In some embodiments, an anion having a radius of less than about 295 pm is proposed as a kosmotropic anion appropriately applicable to the solid-liquid composite electrolyte. When a liquid electrolyte including a salt, which consists of the anion having a radius of less than about 295 pm and a metal cation, and an organic solvent is combined with the sulfide-based solid electrolyte, the corresponding anion has strong interaction with the organic solvent and thereby suppresses the side reaction of the organic solvent with the sulfide-based solid electrolyte, significantly less deteriorating ionic conductivity over time and furthermore, securing high voltage oxidation stability. In addition, when the anion is applied, since types of the organic solvent is not limited, a solvent securing heat resistance and flame retardancy may be introduced. Accordingly, the composite electrolyte according to some embodiments may be suitable for introduction into actual batteries.

The type of anion of the salt according to some embodiments is not limited as long as the anion has a radius of less than about 295 pm. One type of salt may be used, or a mixture of two or more types of salts may be used. The radius of the anion may be, for example, less than or equal to about 290 pm, less than or equal to about 283 pm, less than or equal to about 270 pm, less than or equal to about 250 pm, or less than or equal to about 240 pm, for example, about 100 pm to about 290 pm, or about 160 pm to about 240 pm.

According to some embodiments, the anion satisfying a radius of less than about 295 pm may be, for example, Cl⁻, CH₃COO⁻, NO₃⁻, BF₄⁻, ClO₄⁻, SO₄²⁻, OTf⁻, FSI⁻, or a combination thereof. As a specific example, the anion may be Cl⁻, CH₃COO⁻, NO₃⁻, BF₄⁻, ClO₄⁻, SO₄²⁻, or a combination thereof. As a more specific example, the anion may be NO₃⁻, BF₄⁻, ClO₄⁻, or a combination thereof or BF₄⁻, ClO₄⁻, or a combination thereof.

The anion according to some embodiments may be an anion having a smaller radius than that of PF₆⁻. Referring to “Y. Marcus et al., J. Phys. Chem. B, 2014, 118, 8, 2172 to 2175,” PF₆⁻ has a radius of about 295 pm, ClO₄⁻ has a radius of about 240 pm, SO₄²⁻, BF₄⁻ have a radius of about 230 pm, and NO₃⁻ has a radius of about 179 pm. In addition, referring to “O. Shirai et al., Anal. Sci, 2009, 25, 189 to 193,” Cl⁻ has a radius of about 181 pm. Referring to “F. Sagane et al., Electrochemistry, 2022, 90, 037001,” TFSI⁻ has a radius of about 325 pm, and OTf⁻ has a radius of about 270 pm. Referring to “Y. Tominaga et al., J. Electrochem. Soc. 2015, 162, A3133,” FSI⁻ has a radius of about 283 pm, and referring to “I. Popovic et al., New J. Chem. 2016, 40, 1618 to 1625,” CH₃COO⁻ has a radius of about 162 pm.

A method of measuring the anion radius may not be limited to one theory but may be measured, for example, in a method proposed in “Y. Marcus et al., J. Phys. Chem. B, 2014, 118, 8, 2172 to 2175”.

According to some embodiments, the anion with the specific radius has high kosmotropicity and thus high charge density and static electricity potential and may strongly interact with a solvent. This anion strongly attracts an organic solvent and thus may suppress the side reaction between the organic solvent and the sulfide-based solid electrolyte, improving ionic conductivity of the composite electrolyte and securing oxidation stability, heat resistance, and flame retardancy. Additionally, the anion may contribute to forming a stable SEI layer containing LiF, Li₃N, and organic components.

The anion according to some embodiments may have radial charge density of, for example, less than about −5.44, for example, less than or equal to about −5.5, about −20 to about −5.5, or about −11 to about −5.5, wherein a unit may be about 10⁻¹⁰ C/m. The charge density may be described in “A. J. Page et al., Chem. Sci, 2021, 12, 15007”. The anion, which has charge density within the ranges, exhibits high kosmotropicity and strong interaction with a solvent and thus may effectively suppress a side reaction between the solvent and the sulfide-based solid electrolyte and in addition, even though used at a lower concentration and used even with a solvent with high polarity, may increase an ionic conductivity maintenance rate of the composite electrolyte and secure oxidation safety, heat resistance, flame retardancy, which is advantageous for application to actual batteries.

The anion according to some embodiments has a molecule polarity index (MPI) of greater than about 3.67, for example, greater than or equal to about 4, or about 4 to about 10, or about 4.2 to about 6.1, wherein a unit is eV. The molecule polarity index may be described in “A. Grimaud et al., J. Phys. Chem. B, 2021, 125, 5365 to 5372.”

The anion, which has MPI within the ranges, exhibits high kosmotropicity and strong interaction with a solvent and may effectively prevent the side reaction between the solvent and the sulfide-based solid electrolyte, and even if used at a lower concentration and used even with a solvent having high polarity, may increase the ionic conductivity maintenance rate of the composite electrolyte and secure oxidation safety, heat resistance, and flame retardancy, which is advantageous for application to actual batteries.

The metal cation that pairs with the anion in the salt is not particularly limited in type, and may be, for example, Li⁺, Na⁺, K⁺, Mg²⁺, Al³⁺, Zn²⁺, or a combination thereof, and may be, for example, an alkali metal cation, for example, Li⁺ or Na⁺.

The salt may be, for example, an alkali metal salt, a lithium salt, or a sodium salt.

The salt may include, for example, a compound represented by Chemical Formula 1, a compound represented by Chemical Formula 2, or a combination thereof.

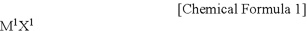

In Chemical Formula 1, M¹ is Li⁺ or Na⁺, and X¹ is a monovalent anion with a radius of less than about 295 pm.

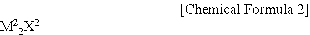

In Chemical Formula 2, M² is Li⁺ or Na⁺, and X² is a divalent anion with a radius of less than 295 pm.

In Chemical Formula 1, X¹ may be, for example, Cl⁻, CH₃COO⁻, NO₃⁻, BF₄⁻, or ClO₄⁻. In Chemical Formula 2, X² may be, for example, SO₄²⁻.

### Organic Solvent of the Liquid Electrolyte

In the solid-liquid composite electrolyte according to some embodiments, the type of organic solvent of the liquid electrolyte is not particularly limited. Both highly polar solvents and solvents with low or no polarity can be used. For example, the highly polar solvent may have high reactivity with the solid electrolyte, causing a side reaction and forming a resistance layer, which may reduce ionic conductivity. However, when using a salt according to some embodiments, even if a polar solvent is used, a strong interaction between the anion of the salt and the organic solvent is exhibited, and thereby chemical side reactions between the organic solvent and the solid electrolyte can be effectively suppressed.

The organic solvent may include, for example, a carbonate-based solvent, an ester-based solvent, an ether-based solvent, a ketone-based solvent, an alcohol-based solvent, an aprotic solvent, or a combination thereof. The organic solvent may be used one type or in a mixture of two or more types.

The carbonate-based solvent may be a cyclic carbonate, a chain carbonate, or a combination thereof. The carbonate-based solvent is often polar, but when used together with anions according to some embodiments, they show strong interaction with the anions and chemical reactions with the solid electrolyte may be suppressed. Accordingly, the ionic conductivity of the solid-liquid composite electrolyte can be improved, advantages of carbonate-based solvents, such as oxidation stability, heat resistance, and flame retardancy, can be secured, and lithium metal stability and single ionic conductivity can be improved, making it possible to apply it to actual batteries.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or a combination thereof.

In one example, the carbonate-based solvent may include vinylene carbonate or an ethylene carbonate-based compound. The ethylene carbonate-based compound may include, for example, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, or a combination thereof. As an example, the ethylene carbonate-based compound may be a halogenated ethylene carbonate, such as fluoroethylene carbonate, difluoroethylene carbonate, chloroethylene carbonate, dichloroethylene carbonate, bromoethylene carbonate, dibromoethylene carbonate, or a combination thereof.

The ester-based solvents may include, for example, methyl acetate, ethyl acetate, n-propyl acetate, dimethyl acetate, methyl propionate, ethyl propionate, α-butyrolactone, decanolide, valerolactone, valonolactone, valerolactone, caprolactone, or a combination thereof.

The ether-based solvents may include, for example, dibutyl ether, monoglyme, diglyme, triglyme, tetraglyme, dimethoxyethane, 2-methyltetrahydrofuran, 2,5-dimethyltetrahydrofuran, tetrahydrofuran, or a combination thereof.

For example, the ether-based solvent may include a glyme-based solvent, a halogenated ether-based solvent, or a combination thereof. The halogenated ether-based solvent may be, for example, a fluorinated ether containing one or more fluorines.

The ketone-based solvent may include, for example, cyclohexanone. The alcohol-based solvent may include, for example, ethyl alcohol, isopropyl alcohol, or a combination thereof.

The aprotic solvent may include, for example, nitriles such as R—CN (R is a C2 to C20 linear, branched, or ring-structured hydrocarbon group and may include a double bond, aromatic ring, or ether group); amides such as dimethylformamide; dioxolanes such as 1,3-dioxolane and 1,4-dioxolane; sulfolanes; or a combination thereof.

Among the aprotic solvents, nitrile-based solvents may include, for example, succinonitrile, adiponitrile, suberonitrile, sebaconitrile, decanedinitrile, dodecanedinitrile, or a combination thereof.

For example, the organic solvent may include a carbonate-based solvent, an ether-based solvent, a nitrile-based solvent, or a combination thereof. Specifically, the organic solvent may include a cyclic carbonate-based solvent, a halogenated ethylene carbonate-based solvent, a glyme-based solvent, a halogenated ether-based solvent, a nitrile-based solvent, or a combination thereof. These organic solvents have good miscibility with the aforementioned salt and can improve the ionic conductivity of the composite electrolyte while simultaneously securing oxidation stability, heat resistance, and flame retardancy, and are advantageous for application to actual batteries.

In some embodiments, a concentration of the liquid electrolyte is not particularly limited. A concentration of the liquid electrolyte can also be expressed as a concentration of the salt. In the past, attempts have been made to increase a concentration of the salt in order to lower the activity of the solvent, thereby increasing the concentration of the solvent and the salt to a mole ratio of almost 1:1. However, when an anion according to some embodiments is applied, ionic conductivity can be increased by sufficiently lowering the activity of the solvent even at a low concentration. Of course, the liquid electrolyte according to some embodiments may be designed to have a high concentration.

For example, the molal concentration of the liquid electrolyte according to some embodiments may be about 0.5 m to about 20 m, for example, about 0.5 m to about 18 m, about 0.5 m to about 15 m, about 0.5 m to about 11 m, about 0.5 m to about 10 m, about 0.5 m to about 8 m, about 0.5 m to about 7 m, or about 1 m to about 5 m.

### Sulfide-Based Solid Electrolyte

The sulfide-based solid electrolyte can be divided into crystalline and non-crystalline types depending on the presence or absence of a crystal structure. The crystalline types may include Thio-LISICON such as Li_{3.25}Ge_{0.25}P_{0.75}S₄, LGPS such as Li₁₀GeP₂S₁₂, and argyrodite structures such as Li₆PS₅Cl. The non-crystalline types may be divided into glass types and glass-ceramic types depending on the difference in heat treatment temperature. The glass types may include, for example, 30Li₂S·26B₂S₃·44LiO, 63Li₂S·36SiS₂·1Li₃PO₄, 57Li₂S·38SiS₂·5Li₄SiO₄, etc. and glass-ceramic types may include, for example, Li_{3.25}P_{0.95}S₄, Li₇P₃S₁₁.

The glass-type sulfide-based solid electrolyte, which has been actively researched by Professor Hayashi's research group in Japan, who has reported that high ionic conductivity of about 10⁻³ S/cm may be realized by mixing Li₂S₅ and P₂S₅ in a ratio of about 7:3, amorphizing them through high-energy ball milling to form a glass-type solid electrolyte, and heat-treating the glass-type solid electrolyte at a low temperature to synthesize a glass-ceramic-type electrolyte.

LGPS, one of the crystalline sulfide-based electrolytes, has been reported to exhibit high ionic conductivity of about 1.2×10⁻² S/cm at room temperature. After the report about LGPS, research on substituting Ge with Si, Sn, and Al or S with Se and the like has been explosively carried out, but all of the resultants exhibited no higher ionic conductivity than that of LGPS but had economic advantages. In addition, argyrodite type Li_{9.54}Si_{1.74}P_{1.44}S_{11.7}Cl_{0.3}, which has been reported in 2016, has recorded ionic conductivity of about 2.5×10⁻² S/cm or so, which is at the same level as that of a liquid electrolyte.

Through these various studies, the sulfide-based solid electrolyte has shown progress in improving ionic conductivity. In addition, the sulfide-based solid electrolyte has high thermal safety and is less likely to cause fire by thermal runaway. Nevertheless, the sulfide-based solid electrolyte has high reactivity with moisture and thus exhibits poor stability in the air such as formation of H₂S when exposed to the air. In addition, the sulfide-based solid electrolyte has an unstable interface in contact with a positive electrode active material and thus deteriorates cyclability and furthermore, since it is solid, may have inevitable interfacial resistance with an electrode. For this reason, various studies for improving reactivity and interface stability of the sulfide-based solid electrolyte with moisture as well as ionic conductivity and commercializing it are being conducted.

The sulfide-based solid electrolyte may be classified into a binary structure such as an argyrodite structure, Li₂S—P₂S₅, and the like, a ternary structure such as Li₂S—GeS₂—P₂S₅ and the like, etc.

The argyrodite-type solid electrolyte is one of the solid electrolytes having the same structure as Ag₉GeS₆, an ore, and exhibiting lithium ionic conductivity. Representative Li-argyrodites having Li+conductivity include Li₇PS₆ and Li₆PS₅X (X═Cl, Br, or I). A method of synthesizing the argyrodite-type sulfide-based solid electrolyte in general includes mechanical milling, annealing after milling, solid sintering, a liquid method, and the like. However, the argyrodite type sulfide-based solid electrolyte is sensitive to air and humidity and thus may require difficult synthesis conditions and have a safety issue due to the use of an organic solvent and also, a problem of deteriorating electrolyte performance due to low solubility in reactants and an incomplete reaction mechanism.

One of the argyrodite types, Li₇PS₆, has been reported to have a cubic phase at a high temperature and an orthorhombic phase at a low temperature, wherein the cubic phase at a high temperature may have much improved ionic conductivity. This compound may be stabilized by replacing sulfur with a halogen anion. When substituted with the halogen element, since vacancy is formed at lithium sites inside argyrodite unit cells, lithium ionic conductivity is improved, and in addition, since the cubic phase is stabilized even at room temperature due to the substitution of the halogen ion, for example, Li₆PS₅Br and Li₆PS₅Cl may exhibit high ionic conductivity of about 10⁻³ S/cm or more. The argyrodite type sulfide-based solid electrolyte may include, for example, Li₇PS₅Br, Li₅PS₄Cl₂, Li₆PS₅Cl, Li₆PS₅Br, Li₆PS₅I, Li₇P₂S₈I, Li₄PS₄I, Li_{9.54}Si_{1.74}P_{1.44}S_{11.7}Cl_{0.3}, Li₇P_{2.9}Mn_{0.1}S_{10.7}I_{0.3}, or a combination thereof but is not limited thereto.

The sulfide-based solid electrolyte is in the form of particles, and an average particle diameter (D₅₀) of the sulfide-based solid electrolyte particle may be less than or equal to about 5.0 μm, for example, about 0.1 pm to about 5.0 μm, about 0.5 pm to about 5.0 μm, about 0.5 pm to about 4.0 μm, about 0.5 μm to about 3.0 μm, about 0.5 pm to about 2.0 pm, or about 0.5 pm to about 1.0 μm. Such a sulfide-based solid electrolyte may effectively penetrate between the positive active materials, and have excellent contact properties with the positive active material and connectivity between the solid electrolyte particles.

### Solid-Liquid Composite Electrolyte Including Sulfide-Based Solid Electrolyte and High-Concentration Liquid Electrolyte

The solid-liquid composite electrolyte according to some embodiments may include a sulfide-based solid electrolyte and a liquid electrolyte, wherein the liquid electrolyte includes a salt and an organic solvent, an anion in the salt is OTf⁻ (trifluoromethane sulfonate; triflate; CF₃SO₃⁻), FSI⁻ (bis(fluorosulfonyl)imide; N(SO₂F)₂⁻), or a combination thereof, and a concentration of the liquid electrolyte is 2.5 m to 20 m.

### Salt of the Liquid Electrolyte

Some embodiments are to suggest a direction of preparing a successful composite electrolyte by considering the Hofmeister effect of a salt, that is, controlling an interaction between the salt and an organic solvent in the liquid electrolyte. The embodiments are to select a kosmotropic anion as an anion forming the salt in the liquid electrolyte, that is, to design an anion with high kosmotropicity. The higher kosmotropicity of the anion, the higher charge density and static electricity potential, which lead to the stronger interaction with the solvent, wherein the anion may not be rather dissolved in the solvent but tends to be salted out or aggregated. In other words, the anion with high kosmotropicity according to some embodiments has strong interaction energy with the solvent, the large solvation number of the anion, and a short bonding distance with the solvent. The anion with high kosmotropicity strongly attracts the solvent, which may deteriorate activity of the solvent and thereby effectively suppress a reaction between the solvent and the sulfide-based solid electrolyte.

In some embodiments, OTf⁻, FSI⁻ or a combination thereof is proposed as a kosmotropic anion appropriately applicable to the solid-liquid composite electrolyte. The anion has high kosmotropicity and thus high charge density and static electricity potential and may strongly interact with a solvent. This anion strongly attracts an organic solvent and thus may suppress the side reaction between the organic solvent and the sulfide-based solid electrolyte, improving ionic conductivity of the composite electrolyte and securing oxidation stability, heat resistance, and flame retardancy. Additionally, the anion may contribute to forming a stable SEI layer containing LiF, Li₃N, and organic components.

In some embodiments, the anion may be FSI⁻.

In addition, when applying a salt composed of the anion and a metal cation and designing the concentration of the salt in the liquid electrolyte to be 2.5 m to 20 m, the anion has a strong interaction with the organic solvent, and thereby suppresses the side reaction of the organic solvent with the sulfide-based solid electrolyte, significantly less deteriorating ionic conductivity over time and furthermore, securing high voltage oxidation stability. In addition, when the concentration and the anion are applied, since types of the organic solvent is not limited, a solvent securing heat resistance and flame retardancy may be introduced. Accordingly, the composite electrolyte according to some embodiments may be suitable for introduction into actual batteries. in addition, when the concentration and the anion are applied, it is advantageous for forming a stable SEI layer containing LiF, Li₃N, and organic components.

The concentration of the liquid electrolyte can be designed from about 2.5 m to about 20 m, for example about 2.8 m to about 20 m, about 3.0 m to about 20 m, about 3.5 m to about 20 m, about 3.8 m to about 20 m, about 4.0 m to about 20 m, about 4.3 m to about 20 m, about 4.5 m to about 20 m, about 5.0 m to about 20 m, about 2.5 m to about 18 m, about 2.5 m to about 16 m, about 4.0 m to about 16 m, about 6.0 m to about 20 m, about 7.0 m to about 20 m, about 8.0 m to about 20 m, or about 9.0 m to about 20 m. When the above concentration is satisfied, side reactions between the liquid electrolyte and the solid electrolyte can be more effectively suppressed.

The metal cation that pairs with the anion in the salt is not particularly limited in type, and may be, for example, Li⁺, Na⁺, K⁺, Mg²⁺, Al³⁺, Zn²⁺, or a combination thereof, and may be, for example, an alkali metal cation, for example, Li⁺ or Na⁺.

The salt may be, for example, an alkali metal salt, a lithium salt, or a sodium salt.

The salt may include, for example, a compound represented by Chemical Formula 11, a compound represented by Chemical Formula 12, or a combination thereof.

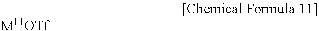

In Chemical Formula 11, M¹¹ is Li⁺ or Na⁺,

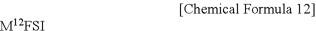

In Chemical Formula 12, M¹² is Li⁺ or Na⁺.

### Organic Solvent of the Liquid Electrolyte

The contents of the organic solvent are substantially the same as those described above, and thus a detailed description thereof will be omitted.

### Sulfide-Based Solid Electrolyte

The contents of the sulfide-based solid electrolyte are substantially the same as those described above, and thus a detailed description thereof will be omitted.

### Solid-Liquid Composite Electrolyte Including Sulfide-Based Solid Electrolyte and Liquid Electrolyte Comprising a Fluorinated Organic Solvent

The solid-liquid composite electrolyte according to some embodiments may include a sulfide-based solid electrolyte and a liquid electrolyte, wherein the liquid electrolyte includes a salt and a fluorinated organic solvent that dissolves the salt.

Fluorinated Organic Solvent that Dissolves the Salt

The liquid electrolyte according to some embodiments uses a fluorinated organic solvent as an organic solvent, that is, an organic solvent in which at least one fluorine is substituted, and among them, a fluorinated organic solvent capable of dissolving a salt. The “fluorinated organic solvent that dissolves the salt” according to some embodiments has low reactivity with sulfide-based solid electrolytes, thereby increasing the chemical stability of the solid-liquid composite electrolyte and improving an ionic conductivity retention rate over reaction time. In addition, since the solvent has high flame retardancy and high thermal stability, the problem of loss or deterioration of flame retardancy due to the addition of liquid electrolyte may be prevented, and fire safety, which is an advantage of using a solid electrolyte, may be maintained. When applying the solvent, the viscosity of the liquid electrolyte is lower than that of a solvent-in-salt or a high-concentration liquid electrolyte, so it is advantageous for impregnation into solid electrolyte particles, or into the positive electrode or negative electrode, and processability may be improved. Furthermore, the solvent according to some embodiments has high oxidation stability, so that side reactions at the interface between the electrolyte and the positive electrode are small even in the high voltage range, and thus, it is possible to drive the semi-solid battery stably in the entire voltage range. Additionally, the solvent may contribute to forming a stable SEI layer containing LiF, Li₃N, and organic components.

The dissolving of a salt may mean, for example, that 0.1 mol or more or 0.5 mol or more of a salt is completely dissolved in 1 L of solvent, or that 0.1 mol or more or 0.5 mol or more of a salt is completely dissolved in 1 kg of solvent.

Specifically, when the salt is dissolved at a concentration of about 1 m or more using only a fluorinated organic solvent that dissolves the salt as the sole solvent, the ionic conductivity of the solution may be about 1×10⁻⁴ S/cm or more.

This means that the fluorinated organic solvent can dissolve salts, is suitable for application to the solid-liquid composite electrolyte according to some embodiments, and realizes excellent ionic conductivity in the battery. For example, an ionic conductivity of a solution in which the salt is dissolved using only a fluorinated organic solvent dissolving the salt as the sole solvent may be about 10⁻² S/cm to about 10⁻⁴ S/cm, for example, about 10⁻² S/cm to about 10⁻³ S/cm, or about 10⁻³ S/cm to about 10⁻⁴ S/cm.

Herein, the salt refers to a salt including a metal cation and an anion paired therewith, and may refer to a salt according to some embodiments described in detail later, as an example, LiFSI (lithium bis(fluorosulfonyl)imide). In addition, under a temperature condition of 25° C., it may mean the ionic conductivity value in the entire concentration range of approximately 0.5 m to 20 m, for example, it may be a value measured at a concentration of about 1 m. For example, when 1 m of LiFSI is dissolved using only a fluorinated organic solvent that dissolves the salt as the sole solvent, an ionic conductivity of greater than or equal to about 10⁻⁴ S/cm can be exhibited. Herein, the ionic conductivity may be measured through electrochemical impedance spectroscopy (EIS), in which it is analyzed, for example, under the conditions of an amplitude of about 10 mV, a frequency of about 1 MHz to about 100 mHz, an air atmosphere, and about 25° C.

A concentration of a solution in which the salt is dissolved using only the fluorinated organic solvent that dissolves the salt as the sole solvent may be greater than or equal to about 0.1 m, for example, greater than or equal to about 0.5 m, or greater than or equal to about 1 m. This means that it can be defined as a solvent that dissolves the salt when the concentration is 0.1 m or more. Herein, a concentration of the solution refers to a concentration at 25° C. and normal pressure. Specifically, the concentration of a solution in which the salt is dissolved using only the fluorinated organic solvent that dissolves the salt as the sole solvent may be about 0.1 m to about 20 m, about 0.2 m to about 20 m, about 0.5 m to about 20 m, or about 1 m to about 20 m. Herein, the salt may refer to a salt according to some embodiments described later, and may be LiFSI as an example. That is, for example, when LiFSI is dissolved at normal pressure at 25° C. using a fluorinated organic solvent that dissolves the salt as the sole solvent, the concentration may be about 0.1 m or more or about 0.5 m or more.

A fluorinated organic solvent that does not dissolve a salt may mean, for example, a solvent that is not recognized as substantially dissolving the salt because the concentration is measured to be less than about 0.1 m when the salt is mixed with the solvent. For example, research on adding highly fluorinated ethers, such as 1,1,2,2-tetrafluoroethyl-2,2,3,3-tetrafluoropropyl ether (TTE), which cannot dissolve existing salts, to composite electrolytes has been proposed, but it cannot be used as a sole solvent because it does not substantially dissolve salts, it is difficult to consider it as a solvent for liquid electrolytes, and because other existing organic solvents should be basically used, it is difficult to secure flame retardancy and oxidation stability and it may require high costs.

The fluorinated organic solvent that dissolves the salt according to some embodiments may specifically include fluorinated ether, fluorinated phosphate, fluorinated carbonate, or a combination thereof.

These solvents are those in which one or more fluorines in the chemical formula are substituted, but are not highly fluorinated compounds. For example, the fluorinated organic solvent that dissolves the salt according to some embodiments may have a ratio of the number of F to the total number of H and F in the chemical formula of about 20% to about 60%, for example, about 25% to about 60%, about 20% to about 50%, or about 20% to about 45%. A solvent in which fluorine is substituted in this ratio is advantageous in dissolving salts, and may be suitable for use as a solvent in the solid-liquid composite electrolyte according to some embodiments.

A specific example of the fluorinated organic solvent that dissolves the salt according to some embodiments may be fluorinated 1,2-diethoxyethane, for example, 1-(2,2,2-trifluoroethoxy)-2-ethoxyethane (F3DEE), 1,2-bis(2,2-difluoroethoxy)ethane (F4DEE), 1-(2,2-difluoroethoxy)-2-(2,2,2-tri fluoroethoxy)ethane (F5DEE), 1,2-bis(2,2,2-trifluoroethoxy)ethane (F6DEE), or a combination thereof. Or, specific examples of the fluorinated organic solvent dissolving the salt may include 2,2,3,3-tetrafluoro-1,4-dimethoxybutane (FDMB), tris(2,2,2-trifluoroethyl)phosphate (TFEP), 2-(2,2,2-trifluoroethoxy)-1,3,2-dioxaphospholane 2-oxide (cyclic TFEP), tris(3-fluoropropyl)phosphate (TFPP), fluoroethylene carbonate (FEC), or a combination thereof.

### Salt

The salt may consist of a metal cation and an anion that pairs with it.

A cation in the salt may be Li⁺, Na⁺, K⁺, Mg²⁺, Al³⁺, Zn²⁺, or a combination thereof, for example, Lit, Nat, or a combination thereof, or for example, Lit.

An anion in the salt may be Cl⁻, CH₃COO⁻, NO₃⁻, BF₄⁻, ClO₄⁻, SO₄²⁻, OTf⁻, FSI⁻, NFSI⁻, PF₆⁻, TFSI⁻, BOB⁻DFOB⁻, or a combination thereof. Herein, OTf is trifluoromethanesulfonate, FSI is bis(fluorosulfonyl)imide, NFSI is bis(nonafluorobutanesulfonyl)imide, and TFSI is bis(trifluoromethanesulfonyl)imide, BOB is bis(oxalato)borate, and DFOB is difluorobis(oxalato)phosphate.

For example, the anion may be BF₄⁻, ClO₄⁻, OTf⁻, FSI⁻, TFSI⁻, or a combination thereof.

### Concentration of Liquid Electrolyte

The concentration of the liquid electrolyte according to some embodiments is not particularly limited. For example, the concentration of the liquid electrolyte may be about 0.5 m to about 20 m, for example about 0.5 m to about 18 m, about 0.5 m to about 15 m, about 0.5 m to about 11 m, about 0.5 m to about 10 m, about 0.5 m to about 8 m, about 0.5 m to about 7 m, or about 1 m to about 5 m.

The liquid electrolyte according to some embodiments has low reactivity with the sulfide-based solid electrolyte even if it is not at a high concentration such as a salt-in-salt electrolyte, and therefore, when combined with a sulfide-based solid electrolyte, an ionic conductivity retention rate over the reaction time is high, thereby providing excellent semi-solid battery performance. Accordingly, the liquid electrolyte according to some embodiments may implement a composite electrolyte that is chemically stable, have high oxidation stability, and have a high ionic conductivity maintenance rate even within a concentration range of about 1 m to about 5 m, or about 1 m to about 3 m, or a molar concentration of about 0.5 M to about 3 M, about 0.8 M to about 2.5 M, or about 1 M to about 2.3 M.

### Other Organic Solvents

The liquid electrolyte may further include other organic solvents as needed in addition to the fluorinated organic solvent that dissolves the salt.

The other organic solvents may include, for example, a carbonate-based solvent, an ester-based solvent, an ether-based solvent, a ketone-based solvent, an alcohol-based solvent, an aprotic solvent, or a combination thereof. The organic solvent may be one type or a mixture of two or more types.

The carbonate-based solvent may be a cyclic carbonate, a chain carbonate, or a combination thereof. When the carbonate-based solvent is additionally included, the ionic conductivity of the solid-liquid composite electrolyte may be improved, and the desirable properties of the carbonate-based solvent, such as oxidation stability, heat resistance, and flame retardancy, can be secured, making it advantageous for application to actual batteries.

The carbonate-based solvent may include, for example, dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), or a combination thereof.

In one example, the carbonate-based solvent may include vinylene carbonate or an ethylene carbonate-based compound. The ethylene carbonate-based compound may include, for example, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, or a combination thereof. As an example, the ethylene carbonate-based compound may be a halogenated ethylene carbonate, such as fluoroethylene carbonate, difluoroethylene carbonate, chloroethylene carbonate, dichloroethylene carbonate, bromoethylene carbonate, dibromoethylene carbonate, or a combination thereof.

The ester-based solvents may include, for example, methyl acetate, ethyl acetate, n-propyl acetate, dimethyl acetate, methyl propionate, ethyl propionate, γ-butyrolactone, decanolide, valerolactone, valonolactone, valerolactone, caprolactone, or a combination thereof.

The ether-based solvents may include, for example, dibutyl ether, monoglyme, diglyme, triglyme, tetraglyme, dimethoxyethane, 2-methyltetrahydrofuran, 2,5-dimethyltetrahydrofuran, tetrahydrofuran, or a combination thereof.

For example, the ether-based solvent may include a glyme-based solvent, a halogenated ether-based solvent, or a combination thereof. The halogenated ether-based solvent may be, for example, a fluorinated ether containing one or more fluorines.

The ketone-based solvent may include, for example, cyclohexanone. The alcohol-based solvent may include, for example, ethyl alcohol, isopropyl alcohol, or a combination thereof.

The aprotic solvent may include, for example, nitriles such as R—CN (R is a C2 to C20 linear, branched, or ring-structured hydrocarbon group and may include a double bond, aromatic ring, or ether group); amides such as dimethylformamide; dioxolanes such as 1,3-dioxolane and 1,4-dioxolane; sulfolanes; or a combination thereof.

Among the aprotic solvents, nitrile-based solvents may include, for example, succinonitrile, adiponitrile, suberonitrile, sebaconitrile, decanedinitrile, dodecanedinitrile, or a combination thereof.

For example, the organic solvent may include a carbonate-based solvent, an ether-based solvent, a nitrile-based solvent, or a combination thereof. Specifically, the organic solvent may include a cyclic carbonate-based solvent, a halogenated ethylene carbonate-based solvent, a glyme-based solvent, a halogenated ether-based solvent, a nitrile-based solvent, or a combination thereof. These organic solvents can improve the ionic conductivity of the composite electrolyte while simultaneously securing oxidation stability, heat resistance, and flame retardancy, and are advantageous for application to actual batteries.

### Sulfide-Based Solid Electrolyte

The contents of the sulfide-based solid electrolyte are substantially the same as those described above, and thus a detailed description thereof will be omitted.

### Nitrogen-Containing Organic Solvent Compound

The liquid electrolyte of solid-liquid composite electrolyte according to some embodiments may include a nitrogen-containing organic solvent compound.

The nitrogen-containing organic solvent compound may include, for example, an amine, amide, imidazole, pyridine, urea, carbamic acid, nitrile, a derivative thereof, or a combination thereof.

Specific examples of the nitrogen-containing organic solvent compound may include methylamine, ethylamine, dimethylamine, diethylamine, trimethylamine, triethylamine, N,N-dimethylacetamide (DMAc), N,N-dimethylformamide (DMF), pyridine, 2-methylpyridine, 4-vinylpyridine, 1-ethyl-3-methylimidazolium salt (EMIM⁺), dimethylurea, ethyl carbamate, N,N′-dimethylurea, diphenyl urea, acetonitrile (AN), propionitrile, triphenylamine (TPA), trimethylamine N-oxide, or a combination thereof.

The nitrogen-containing organic solvent compound according to some embodiments has high flame retardancy and high thermal stability, the problem of loss or deterioration of flame retardancy due to the addition of liquid electrolyte may be prevented, and fire safety, which is an advantage of using a solid electrolyte, may be maintained. Furthermore, the nitrogen-containing organic solvent compound according to some embodiments has high oxidation stability, so that side reactions at the interface between the electrolyte and the positive electrode are small even in the high voltage range, and thus, it is possible to drive the semi-solid battery stably in the entire voltage range. Additionally, the nitrogen-containing organic solvent compound may contribute to forming a stable SEI layer containing LiF, Li₃N, and organic components.

### Other Components of the Solid-Liquid Composite Electrolyte

### Other Types of Solid Electrolytes

The solid-liquid composite electrolyte according to any of the above described embodiments may further include other types of solid electrolytes in addition to the sulfide-based solid electrolyte, and may further include, for example, an oxide-based solid electrolyte, a halide-based solid electrolyte, a complex hydride, or a combination thereof.

The oxide-based inorganic solid electrolyte may include, for example, Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN—PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al,Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet type ceramics Li₃₊ₓLa₃M₂O₁₂ (M=Te, Nb, or Zr, and x is an integer of 1 to 10), or a combination thereof.

The halide-based solid electrolyte includes a halogen element as a main component, and a ratio of the halogen element to all elements constituting the solid electrolyte may be greater than or equal to about 50 mol %, greater than or equal to about 70 mol %, greater than or equal to about 90 mol %, or 100 mol %. As an example, the halide-based solid electrolyte may not contain elemental sulfur.

The halide-based solid electrolyte may contain a lithium element, a metal element other than lithium, and a halogen element. The metal element other than lithium may be, for example, Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, and for example, it may be Cl, Br, or a combination thereof. The halide-based solid electrolyte may be, for example, LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X is F, Cl, Br, I, or a combination thereof, and 2≤a≤3). The halide-based solid electrolyte may include, for example, Li₂ZrCl₆, Li_{2.7}Y_{0.7}Zr_{0.3}Cl₆, Li_{2.5}Y_{0.5}Zr_{0.5}Cl₆, Li_{2.5} In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{2.6}Hf_{0.4}Yb_{0.6}Cl₆, or a combination thereof.

The complex hydride may be, for example, composed of a metal cation (M) and a complex-anion in the form of M′Hₙ (MM′Hₙ). The metal cation (M) may be, for example, Li, Na, K, Mg, Sc, Cu, Zn, Zr, or Hf, and the complex-anion may be [BH₄]⁻, [NH₂]⁻, [AlH₄]⁻, [NH]²⁻, [AlH₆]³⁻, or [NiH₄]⁴⁻. The complex hydride may refer to “M. Matsuo, S.-i. Orimo, Adv. Energy Mater. 2011, 1, 161”.

### Additives

In some embodiments, the solid-liquid composite electrolyte according to any of the above described embodiments may further comprise the additive. For example, the liquid electrolyte in the solid-liquid composite electrolyte may include the additives. The additive may be dissolved in the liquid electrolyte, and the liquid electrolyte in which the additive is dissolved may fill the pores between the solid electrolyte particles.

The additive may serve to stabilize the interface between the composite electrolyte and the electrode as well as the interface between the sulfide-based solid electrolyte and the liquid electrolyte. Furthermore, depending on the type, the additive may improve lithium ionic conductivity, help lithium diffusion into the electrode, help homogeneous lithium deposition, improve cycling performance, enhance rate capability, or improve the mechanical stability and Young's modulus of the battery. By introducing a liquid electrolyte and adding the additive, a region in which capacity cannot be realized because the solid electrolyte alone does not contact a positive electrode may be utilized, and thus a full capacity of the positive electrode may be utilized and rate characteristics may be improved. Additionally, the additive may contribute to forming a stable SEI layer containing LiF, Li₃N, and organic components.

In general, solid electrolytes have a problem in that they cannot dissociate or ionize the additive, or the solid electrolyte and the additive are not evenly mixed, so the role of the additive cannot be fully realized. However, according to some embodiments, it is possible to complex a liquid electrolyte in which additives are dissolved or mixed with a solid electrolyte. Accordingly, the additive can be evenly distributed in the composite electrolyte and can effectively perform its role as an additive, such as stabilizing the interface between the composite electrolyte and the electrode.

For example, the additive may comprise TMSB (tris(trimethylsilyl)borate), TMSP (tris(trimethylsilyl)phosphate), VC (vinylene carbonate), ES (ethylene sulfite), DTD (1,3,2-dioxathiolane 2,2-dioxide), PGS (1,2-propyleneglycol sulfite), DMS (dimethyl sulfate), FEC (fluoroethylene carbonate), TPFPB (tris(pentafluorophenyl)borane), DFDEC (bis(2,2,2-trifluoroethyl)carbonate), LiFMDFB (lithium fluoromalonato(difluoro)borate), TFPC (trifluoropropylene carbonate), LiDFP (lithium difluorophosphate), DFEC (difluoroethylene carbonate), alkoxysilane, SA (succinic anhydride), LiBOB (lithium bis(oxalato)borate), MEC (methylene ethylene carbonate), PFPI (pentafluorophenyl isocyanate), NACA (N-acetylcaprolactam), VPLi (vinyl phosphonic acid dilithium salt), IEM (2-Isocyanatoethyl methacrylate), AgNO₃, LiPO₂F₂, LiNO₃, SN (succinonitrile), AN (adiponitrile), HTCN (1,3,6-Hexanetricarbonitrile), PS (1,3-propane sultone) or a combination thereof.

Specifically, the additive may comprise DTD (1,3,2-di-oxathiolane 2,2-dioxide), VC (vinylene carbonate), ES (ethylene sulfite), or combinations thereof.

The above-described additive types have low reactivity with the sulfide-based solid electrolyte and high miscibility with the above-mentioned liquid electrolyte. In addition, these additives may form a stable interphase between the composite electrolyte and the electrode as well as between the sulfide-based solid electrolyte and the liquid electrolyte, and may improve overall battery performance such as cyclability.

The additive may be included in an amount of about 0.1 wt % to about 10 wt %, for example, about 0.5 wt % to about 9 wt %, about 1 wt % to about 8 wt %, about 2 wt % to about 7 wt %, or about 3 wt % to about 6 wt % based on 100 wt % of a total of the additive, the salt, and the organic solvent. When the additive is included in the above content range, the interface between the electrode and the composite electrolyte can be stabilized without degrading battery performance, and overall battery performance such as cyclability may be improved.

### Diluents

In some embodiments, the solid-liquid composite electrolyte according to any of the above described embodiments may further comprise the diluent. For example, the liquid electrolyte in the solid-liquid composite electrolyte may include the diluent. The liquid electrolyte including the diluent may fill the pores between the solid electrolyte particles.

The diluent may refer to a substance that lowers the viscosity of the liquid electrolyte, or a liquid component that does not dissolve the salt. For example, a solubility of the salt in 100 g of the diluent at 25° C. may be less than about 20 g or about 10 g or about 5 g.

The diluent may serve to lower the viscosity of the liquid electrolyte and improve the interfacial stability of the composite electrolyte and the electrode as well as the interfacial stability of the solid-based solid electrolyte and the liquid electrolyte.

Furthermore, the diluent may further improve electrochemical performance by changing the solvation structure. Solvation structure refers to the structural relationship between the cation and anion of the salt and the solvent. A typical liquid electrolyte can be said to have a solvent-separated ion pair (SSIP) structure in which cations and anions are separated by a solvent. Here, the structure in which cations and anions can contact without being separated by the solvent is called a contact ion pair (CIP), and when these structures come together, it becomes an aggregate (AGG) structure, and a structure in which anions come into contact with more cations instead of the solvent is called aggregate-II (AGG-II or AGG+). When the diluent is included in the composite electrolyte, the solvation structure of the liquid electrolyte may be changed from solvent-based to anion-based (CIP, AGG, AGG-II, etc.), and thus the electrochemical performance of the battery may be further improved.

For example, the diluent may comprises MDFSA (methyl 2,2-difluoro-2-(fluorosulfonyl)acetate), FB (fluorobenzene), TFB (1,3,5-trifluorobenzene), DFB (1,2-difluorobenzene), TTE (1,1,2,2-tetrafluoroethyl-2,2,3,3-tetrafluoropropyl ether), BTFE (bis(2,2,2-trifluoroethyl) ether), TFEO (tris(2,2,2-trifluoroethyl) orthoformate), TFME (1,1,2,2-tetrafluoroethyl methyl ether), D2 (tetrafluoro-1-(2,2,2-trifluoroethoxy)ethane), M3 (methoxyperfluorobutane), HTE (1,1,2,3,3,3-hexafluoropropyl-2,2,2-trifluoroethylether), TFETFE (1,1,2,2-tetrafluoroethyl-2,2,2-trifluoroethyl ether), OTE (1H,1H,5H-octafluoropentyl-1,1,2,2-tetrafluoroethyl ether), DCM (dichloromethane), TFMP (1,1,2,2-tetrafluoro-3-methoxypropane), SFE (fluoromethyl 1,1,1,3,3,3-hexafluoroisopropyl ether), PFPN (ethoxy (pentafluoro)cyclotriphosphazene), TFMB (trifluoromethoxybenzene), BZTF (benzotrifluoride), FEE (1,1,2,2-tetrafluoro-1-(2,2,2-trifluoroethoxy)ethane, OFDEE (1,2-bis(1,1,2,2-tetrafluoroethoxy)ethane) or combinations thereof.

The diluent may be included in an amount of about 1 vol % to about 80 vol %, for example, about 1 vol % to about 75 vol %, about 1 vol % to about 70 vol %, about 1 vol % to about 60 vol %, about 1 vol % to about 50 vol %, about 1 vol % to about 40 vol %, about 5 vol % to about 35 vol %, about 10 vol % to about 30 vol %, or about 15 vol % to about 25 vol % based on 100 vol % of a total of the diluent and a liquid electrolyte in which the salt is dissolved in the organic solvent. When the diluent is included within the range, the viscosity of the liquid electrolyte may be lowered to improve lithium ion conductivity, stability of the interface between the composite electrolyte and the electrode may be improved, and the solvation structure of the liquid electrolyte may be changed to further improve electrochemical performance.

### Polymers

In some embodiments, the solid-liquid composite electrolyte according to any of the above described embodiments may further comprise the polymer.

The polymer may be evenly distributed within the composite electrolyte, for example, may be located in pores between solid electrolyte particles. The polymer may retain the liquid electrolyte within its network structure, thereby stabilizing its distribution in the interstitial pores of the solid electrolyte particles.

In some embodiments, at least part of the liquid electrolyte may be immobilized within the polymer phase of the composite electrolyte.

In some embodiments, the solid-liquid composite electrolyte includes a plurality of sulfide-based solid electrolyte particles, and the polymer containing the liquid electrolyte in the pores between the particles.

For example, the polymer may comprise a functional group including an acrylic group, an amide group, a nitrile group, a diazo group, an azide group, or a combination thereof.

Specifically, the polymer may comprise acylate-based polymer, acrylamide-based polymer, acrylonitrile-based polymer, diazo-based polymer, azide-based polymer, or combinations thereof.

The acylate-based polymer may comprise (meth)acrylic acid, methyl (meth)acrylate, ethyl (meth)acrylate, n-butyl (meth)acrylate, n-hexyl (meth)acrylate, poly(ethylene glycol) methyl ether (meth)acrylate, poly(ethylene glycol) (meth)acrylate, poly(ethylene glycol) diacrylate, 2-(dimethylamino)ethyl (meth)acrylate, 2-cyanoethyl acrylate, diallyl carbonate, trimethylolpropane propoxylate triacrylate, trimethylolpropane ethoxylate triacrylate, trimethylolpropane triacrylate, or a combination thereof.

The acrylamide-based polymer may comprise methylacrylamide, N-[tris(3-acrylamidopropoxymethyl)-methyl]acrylamide)], acrylamide, N,N′-1,2-ethanediylbis{N-[2-(acryloylamino)-ethyl]acrylamide}, or a combination thereof.

The acrylonitrile-based polymer may comprise acrylonitrile, 2-cyanoethyl acrylate, or a combination thereof.

The diazo-based polymer may comprise 6-diazo-5-oxo-L-norleucine, 1-diazo-2-naphthol-4-sulfonic acid, or a combination thereof.

The azide-based polymer may comprise 3-azido-1-propanamine, 11-azido-3,6,9-trioxaundecan-1-amine, 2-(dodecylthiocarbonothioylthio)-2-methylpropionic acid 3-azido-1-propanol ester, or a combination thereof.

The polymer may be present (e.g., included) in an amount of about 1 wt % to about 30 wt %, for example about 1 wt % to about 25 wt %, 1 wt % to about 20 wt %, 1 wt % to about 18 wt %, about 1 wt % to about 15 wt %, about 1 wt % to about 10 wt %, or about 3 wt % to about 8 wt % based on total weight of the polymer, the salt, and the organic solvent. Within this range, the polymer enables effective immobilization of the liquid electrolyte and promotes uniform ion transport, contributing to enhanced electrochemical stability.

In some embodiments, the polymer may be crosslinked in the solid-liquid composite electrolyte. The crosslinked polymer may contain the liquid electrolyte in the crosslinked polymer structure, and thus may help the liquid electrolyte to be uniformly distributed between the pores of the solid electrolyte particles.

### Other Components

The composite electrolyte according to some embodiments may further include other types of a salt, a binder, an organic dispersant, ionic liquid, a conductive polymer, additives, etc. in addition to the aforementioned salt and organic solvent.

The binder may include, for example a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, a butyl rubber, a fluorine rubber, a natural rubber, polybutadiene, polydimethylsiloxane, polyethyleneoxide, polyvinylpyrrolidone, polyvinylpyridine, chlorosulfonated polyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The ionic liquid has a melting point below room temperature, so it is in a liquid state at room temperature and refers to a salt or room temperature molten salt composed of ions alone. The ionic liquid may include at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations, and at least one anion selected from b) BF₄⁻, PF₆⁻, AsF₆⁻, SbF₆⁻, AlCl₄⁻, HSO₄⁻, ClO₄⁻, CH₃SO₃⁻, CF₃CO₂⁻, Cl, Br, I, BF₄⁻, SO₄⁻, CF₃SO₃⁻, FSO₂₂N⁻, (C₂F₅SO₂)₂N⁻, (C₂F₅SO₂, CF₃SO₂)N⁻, and (CF₃SO₂)₂N⁻. The ionic liquid may include, for example, one or more selected from N-methyl-N-propylpyrroldinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

The solid-liquid composite electrolyte according to some embodiments may be in the form of a type of pellet or a film. The solid-liquid composite electrolyte can be applied to various positions in the battery. For example, it may be mixed with a positive electrode active material to form a positive electrode, a solid electrolyte film, or mixed with a negative electrode active material to form a negative electrode.

### Composite Electrolyte Film

Some embodiments provide a composite electrolyte film including the above solid-liquid composite electrolyte. The composite electrolyte film may have, for example, a thickness of about 20 μm to about 1000 μm, about 20 μm to about 800 μm, about 20 μm to about 700 μm, or about 200 μm to about 600 μm. The composite electrolyte film according to some embodiments is disposed between positive and negative electrodes and thus may secure battery safety as well as realize high ionic conductivity and thereby, improve cyclability and rate capabilities of a battery.

### Negative Electrode

The negative electrode may be a general negative electrode containing various negative electrode active materials such as carbon-based, silicon-based, etc.; it may be a negative electrode made of metal such as lithium metal; or it may be a precipitated negative electrode that acts as a negative electrode active material wherein the negative electrode active material is not initially present, but lithium metal, etc. is precipitated during charging.

As an example, the negative electrode may include a current collector and a negative electrode active material layer on the current collector. The negative electrode active material layer includes a negative electrode active material, may further include a binder and/or a conductive material, and may optionally include the aforementioned composite electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative active material. Examples of crystalline carbon may include natural graphite, artificial graphite, or a combination thereof, and examples of amorphous carbon include soft carbon or hard carbon, a mesophase pitch carbonized product, and calcined coke. The carbon-based negative electrode active material may be irregular-shaped, plate-shaped, flake-shaped, spherical, or fibrous.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative active material or a Sn-based negative active material. The Si-based negative active material may include silicon, a silicon-carbon composite, SiOₓ (0<x<2), a silicon alloy, and the like and the Sn-based negative active material may include Sn, SnO₂, a tin alloy, and the like. At least one of these materials may be mixed with SiO₂. For example, the negative electrode active material may include a composite of silicon and carbon.

The binder may be a water-insoluble binder, a water-soluble binder, or a combination thereof.

The water-insoluble binder may include polyvinylchloride, carboxylated polyvinylchloride, polyvinylfluoride, an ethylene oxide-containing polymer, ethylene propylene copolymer, polystyrene, polyvinylpyrrolidone, polyurethane, polytetrafluoroethylene, polyvinylidene fluoride, polyethylene, polypropylene, polyamideimide, polyimide, or a combination thereof.

The water-soluble binder may include a rubber binder or a polymer resin binder. The rubber-based binder may be selected from a nitrile butadiene rubber, a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, polybutadiene, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound may be further included as a type of thickener. As the cellulose-based compound, one or more of carboxymethyl cellulose, hydroxypropylmethyl cellulose, methyl cellulose, or alkali metal salts thereof may be mixed and used. The alkali metal may be Na, K, or Li.

The conductive material may be, for example, a carbon-based material such as natural graphite, artificial graphite, carbon black, acetylene black, ketjen black, a carbon fiber, a carbon nanofiber, or a carbon nanotube; a metal-based material of a metal powder or a metal fiber including copper, nickel, aluminum silver, and the like; or a conductive polymer such as a polyphenylene derivative; or a mixture thereof.

### Positive Electrode

The positive electrode may include a current collector and a positive electrode active material layer on the current collector, and the positive electrode active material layer may include a positive electrode active material and optionally may include a solid electrolyte. The positive active material layer may optionally further include a binder and/or a conductive material.

### Positive Electrode Active Material

The positive electrode active material can be applied without limitation as long as it is commonly used in rechargeable batteries. For example, the positive electrode active material may be a compound capable of intercalating and deintercalating lithium, and may include, for example, a lithium transition metal composite oxide.

The positive electrode active material may include, for example, lithium nickel-based oxide, lithium cobalt-based oxide, lithium manganese-based oxide, lithium iron phosphate-based compound, cobalt-free nickel-manganese-based oxide, or a combination thereof, and may include, for example, lithium nickel oxide (LNO), lithium cobalt oxide (LCO), lithium nickel cobalt oxide (NC), lithium nickel cobalt aluminum oxide (NCA), lithium nickel cobalt manganese oxide (NCM), lithium nickel manganese oxide (NM), lithium manganese oxide (LMO), lithium iron phosphate (LFP), or a combination thereof.

The positive electrode active material may be included in an amount of about 55 wt % to about 99.5 wt %, for example about 65 wt % to about 95 wt %, or about 75 wt % to about 91 wt % based on 100 wt % of the positive electrode active material layer.

### Binder

The binder serves to adhere the positive electrode active material particles to each other and to the current collector. Examples of the binder may include a nitrile butadiene rubber, polybutadiene, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like, but are not limited thereto. An amount of the binder in 100 wt % of the positive electrode active material layer may be approximately about 0.1 wt % to about 5 wt %.

### Conductive Material

The conductive material may include a carbon-based material such as natural graphite, artificial graphite, carbon black, acetylene black, ketjen black, a carbon fiber, a carbon nanofiber, carbon nanotube, and the like; a metal-based material of a metal powder or a metal fiber including copper, nickel, aluminum, silver, and the like; a conductive polymer such as a polyphenylene derivative; or a mixture thereof. In 100 wt % of the positive electrode active material layer, an amount of the conductive material may be about 0 wt % to about 3 wt %, or about 0.01 wt % to about 2 wt %.

The aforementioned composite electrolyte may be included in an amount of about 0.1 wt % to about 45 wt %, for example, about 1 wt % to about 35 wt %, about 5 wt % to about 30 wt %, about 8 wt % to about 25 wt %, or about 10 wt % to about 20 wt % based on 100 wt % of the positive electrode active material layer.

The shape of the semi-solid rechargeable battery is not particularly limited, and may be, for example, coin-shaped, button-shaped, sheet-shaped, stacked-shaped, cylindrical, etc. The semi-solid rechargeable battery according to some embodiments can be applied to various electronic devices, such as electric vehicles and power storage devices.

Hereinafter, examples of the present invention and comparative examples are described. It is to be understood, however, that the examples are for the purpose of illustration and are not to be construed as limiting the present invention.

### Example 1

150 mg of an argyrodite-type sulfide-based solid electrolyte (Li₆PS₅Cl) was prepared and pressed at 370 MPa for 1 minute and then, stabilized at 74 MPa for 12 hours to prepare a solid electrolyte pellet with a thickness of about 600 μm or less and an area of 1.33 cm².

A liquid electrolyte was prepared by dissolving LiFSI at a molal concentration of 5.5 m in an organic solvent of propylene carbonate and fluoroethylene propylene carbonate mixed in a volume ratio of 93:7.

40 μl of the liquid electrolyte was dropped on the solid electrolyte pellet and then maintained for 10 minutes to prepare a solid-liquid composite electrolyte. Herein, an amount of the liquid electrolyte was about 10 vol % based on 100 vol % of the solid-liquid composite electrolyte.

A unit cell was manufactured by interposing the solid-liquid composite electrolyte between two lithium metal electrodes. This unit cell was placed into a laminate film and subjected to hydrostatic pressure pressing to manufacture a semi-solid rechargeable battery.

### Comparative Example 1

Except for not using a solid-liquid composite electrolyte and using only the solid electrolyte alone, the battery was manufactured by a method substantially identical to Example 1. That is, by interposing the solid electrolyte from Example 1 between the positive electrode and negative electrode, an all-solid-state rechargeable battery was prepared according to Comparative Example 1.

### Evaluation Example 1: XPS

For the lithium metal symmetrical batteries according to Example 1 and Comparative Example 1, initial charge and discharge were performed with a capacity of 1 mAh/cm² by applying a current density of 0.5 mA/cm² for 2 hours each for charge and discharge. Subsequently, the batteries were disassembled, and XPS analysis was performed on the surface of the negative electrode, and the results are shown in FIG. 2 and Table 1. XPS analysis was performed using a K-alpha, Thermo VG, U.K. and the analysis conditions were as follows.
X-ray source: Al Ka 1486.6 eV
Charge neutralization: Dual beam source
Ar⁺ Gun: 200 eV

TABLE 1

| | Comparative Example 1 | Example 1 |
|---|---|---|
| F 1s (LiF) peak area | 0 | 3,077 |
| N 1s peak area | 0 | 672 |
| C 1s except for C—C peak area | 0 | 15,386 |
| R₁ | — | 0.244 |
| R₂ | — | 0.196 |

In FIG. 2, comparing the S 2p spectra in the first row, Example 1 not only exhibited the P—S—Li and Li₂S peaks observed in Comparative Example 1 but also showed additional N—S—N, —SO₂ and RSO₃ peaks, which are understood to be derived from the liquid electrolyte of the solid-liquid composite electrolyte. In the S 2p spectra of Example 1, the peaks that also appeared in Comparative Example 1 may be attributed to the solid electrolyte, and their peak areas were calculated to be approximately 54% based on total peak areas. Furthermore, in the S 2p spectra of Example 1, the peaks not observed in Comparative Example 1 may be attributed to the solid-liquid composite electrolyte, and their peak areas were calculated to be approximately 46% based on total peak areas. That is, in the S 2p spectra from the XPS analysis of the SEI according to the embodiment, the ratio of the peak areas attributed to the solid electrolyte to those attributed to the solid-liquid composite electrolyte was found to satisfy a range of approximately 40:60 to 60:40.

When comparing the N 1s spectra in the second row of FIG. 2, it is confirmed that Example 1 exhibits peaks such as Li₃N and N—SOₓ unlike Comparative Example 1. This is understood to be an unique SEI characteristic derived from the solid-liquid composite electrolyte according to the embodiment.

When comparing the F 1s spectra in the third row of FIG. 2, Example 1 exhibited a strong LiF peak unlike Comparative Example 1, which is understood to be an unique SEI characteristic derived from the solid-liquid composite electrolyte according to the embodiment.

When comparing the C 1s spectra in the fourth row of FIG. 2, Example 1 showed peaks such as CO₃²⁻, C—O, and C—Li unlike Comparative Example 1, which are understood to be an unique SEI characteristics derived from the solid-liquid composite electrolyte according to the embodiment.

Table 1 displays the total area of the peaks observed at F 1s spectra in the XPS of FIG. 2, the total area of the peaks observed at N 1s, and the total area of the peaks at C 1s excluding the C—C bonding peak. It also presents the values of Ri calculated using Formula 1 and R₂ calculated using Formula 2.

Referring to Table 1, R₁ of Example 1 satisfies at least 0.2, and R₂ satisfies at least 0.1. In Example 1, the solid-liquid composite electrolyte according to an embodiment and the negative electrode interact each other to form a characteristic SEI. In this SEI, inorganic components such as LiF and Li₃N, as well as organic components mainly formed by the decomposition of the organic solvent of the liquid electrolyte, are formed at a specific ratio. This SEI layer may stabilize the negative electrode and improve the cycle stability of the batteries.

### Evaluation Example 2: Cycling Stability

After conducting initial charging and discharging identically to Evaluation Example 1 for the lithium metal symmetrical batteries according to Example 1 and Comparative Example 1, these batteries were repeatedly charged and discharged at a current density of 0.5 mA/cm² for over 1,000 hours at 25° C., at a pressure of 5 MPa and without applying pressure (e.g., 0 MPa), respectively.

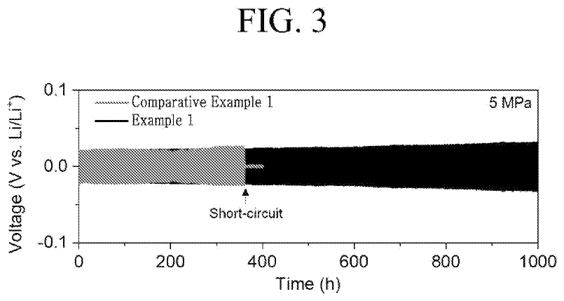

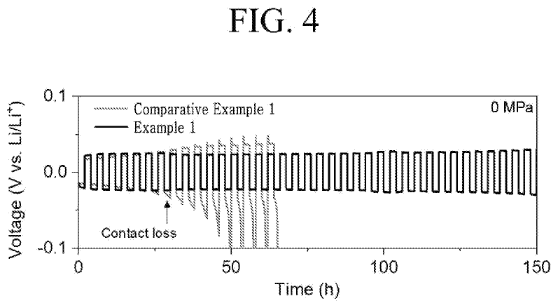

FIG. 3 shows a graph of voltage changes over time for Example 1 and Comparative Example 1 when charge and discharge were repeated at 5 MPa. FIG. 4 shows a graph of voltage changes over time for Example 1 and Comparative Example 1 when charge and discharge were repeated at 0 MPa.

Referring to FIG. 3, the cell of Comparative Example 1 had a short circuit around 370 hours, whereas the cell of Example 1 exhibited stable cycle operation up to 1,000 hours. Referring to FIG. 4, the cell of Comparative Example 1 had a contact loss and a short circuit around 30 hours, while the cell of Example 1 showed stable cycle operation up to 150 hours.

Ultimately, Example 1 achieves excellent cycle stability by forming a stable SEI according to some embodiments.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A semi-solid rechargeable battery, comprising
a positive electrode,
a negative electrode,
a composite electrolyte film comprising a solid-liquid composite electrolyte between the positive electrode and the negative electrode, and
a solid electrolyte interphase (SEI) layer comprising LiF, Li₃N, and organic components on the surface of the negative electrode,
wherein the solid-liquid composite electrolyte comprises a sulfide-based solid electrolyte and a liquid electrolyte including a salt and an organic solvent.

2. The semi-solid rechargeable battery of claim 1, wherein
the organic components in the SEI layer comprise —CO₃, —CO—, —CO₂—, —OCH₂—, —CH₂—, —C—Li, C—F, or combination thereof.

3. The semi-solid rechargeable battery of claim 1, wherein
the organic components in the SEI layer comprise Li₂CO₃, ROCO₂Li (R is an organic group), Li₂C₂, polymeric species, or a combination thereof.

4. The semi-solid rechargeable battery of claim 1, wherein
the SEI layer further comprises —SO₂, —SO₃, S—N—S, N—S—N, N—SOₓ (2≤x≤4), SOₓ—F (2≤x≤3), LiₓSO_{y} (1≤x≤2, 0≤y≤6), P—S—Li, Li₂O, LiOH, LiNSO₂F, Li₂SO₃, LiNO₂, LiNO₃, Li₂S, Li₂SO₄, LiCl, LiBr, LiI, or combination thereof.

5. The semi-solid rechargeable battery of claim 1, wherein
a ratio R₁ of a peak area of an inorganic component to a peak area of an organic component calculated by Formula 1 is greater than or equal to about 0.2 in the XPS analysis of the SEI layer.
$${R}_{1} = ( a peak area of LiF , {Li}_{3} N and N - {SO}_{x} ) / ( a peak area of C 1 s except for C - C ) \qquad [ Formula 1 ]$$

6. The semi-solid rechargeable battery of claim 1, wherein
a ratio R₂ of a peak area of an inorganic component to a peak area of an organic component and the inorganic component calculated by Formula 2 is greater than or equal to about 0.1 in a XPS analysis of the SEI layer.
$${R}_{2} = ( a peak area of LiF , {Li}_{3} N and N - {SO}_{x} ) / ( a peak area of LiF , {Li}_{3} N , N - {SO}_{x} and C 1 s except for C - C ) \qquad [ Formula 2 ]$$

7. The semi-solid rechargeable battery of claim 1, wherein
a content of fluorine is greater than or equal to 5 at % and a content of nitrogen is greater than or equal to 3 at % based on the total 100 at % of elements in XPS analysis of the SEI layer.

8. The semi-solid rechargeable battery of claim 1, wherein
the SEI layer is formed by charging at least once under the conditions of about 0.01 mA/cm² to about 20 mA/cm² for about 1 second to about 20 hours.

9. The semi-solid rechargeable battery of claim 1, wherein
a thickness of the SEI layer is about 5 nm to about 5 μm.

10. The semi-solid rechargeable battery of claim 1, wherein
the SEI layer is in contact with both the solid electrolyte and the liquid electrolyte of the solid-liquid composite electrolyte.

11. The semi-solid rechargeable battery of claim 1, wherein
the salt of the liquid electrolyte comprises a metal cation and an anion with a radius of less than about 295 μm.

12. The semi-solid rechargeable battery of claim 11 wherein
the anion in the salt is Cl⁻, CH₃COO⁻, NO₃⁻, BF₄⁻, ClO₄⁻, SO₄²⁻, OTf⁻, FSI⁻, or a combination thereof.

13. The semi-solid rechargeable battery of claim 1, wherein
an anion in the salt is OTf⁻, FSI⁻, or a combination thereof, and
a concentration of the liquid electrolyte is about 2.5 m to about 20 m.

14. The semi-solid rechargeable battery of claim 13, wherein
the salt comprises a lithium bis(fluorosulfonyl)imide (LiFSI), and
the concentration of the liquid electrolyte is about 4 m to about 16 m.

15. The semi-solid rechargeable battery of claim 1, wherein
the organic solvent of the liquid electrolyte comprises a fluorinated organic solvent that dissolves the salt.

16. The semi-solid rechargeable battery of claim 15, wherein
the fluorinated organic solvent that dissolves the salt includes a fluorinated ether, fluorinated phosphate, fluorinated carbonate, or a combination thereof.

17. The semi-solid rechargeable battery of claim 15, wherein
the liquid electrolyte further comprise the nitrogen-containing organic solvent compound, and
the nitrogen-containing organic solvent compound includes methylamine, ethylamine, dimethylamine, diethylamine, trimethylamine, triethylamine, N,N-dimethylacetamide (DMAc), N,N-dimethylformamide (DMF), pyridine, 2-methylpyridine, 4-vinylpyridine, 1-ethyl-3-methylimidazolium salt (EMIM⁺), dimethylurea, ethyl carbamate, N,N′-dimethylurea, diphenyl urea, acetonitrile (AN), propionitrile, triphenylamine (TPA), trimethylamine N-oxide, or a combination thereof.

18. The semi-solid rechargeable battery of claim 1, wherein
the sulfide-based solid electrolyte is included in an amount of about 10 vol % to about 99.99 vol % and the liquid electrolyte is included in an amount of about 0.01 vol % to about 90 vol % based on 100 vol % of the solid-liquid composite electrolyte.

19. The semi-solid rechargeable battery of claim 1, wherein
the sulfide-based solid electrolyte is included in an amount of about 70 vol % to about 99.99 vol % and the liquid electrolyte is included in an amount of about 0.01 vol % to about 30 vol % based on 100 vol % of the solid-liquid composite electrolyte.

20. The semi-solid rechargeable battery of claim 1, wherein
the sulfide-based solid electrolyte is in the form of particles, the average particle diameter (D₅₀) of the particles is about 0.1 μm to about 5 μm, and
the solid-liquid composite electrolyte includes a plurality of sulfide-based solid electrolyte particles, and a liquid electrolyte in the pores between the particles.

21. The semi-solid rechargeable battery of claim 1, wherein
the solid-liquid composite electrolyte further comprises at least one of an additive, a diluent, and a polymer.

22. The semi-solid rechargeable battery of claim 1, wherein
the negative electrode comprises lithium metal, lithium metal alloy, silicon-based active material, carbon-based active material, or combination thereof.
